(19) United States
(12) Patent Application Publication
(10) Pub. No.: US 2026/0217048 A1
(43) Pub. Date: Jul. 30, 2026

(54) Clip and Post for Switchable Notebook Covers and Accessories

(71) Applicant: Pedro Martir, JR., Ewa Beach, HI (US)

(72) Inventor: Pedro Martir, JR., Ewa Beach, HI (US)

(21) Appl. No.: 19/423,924

(22) Filed: Dec. 17, 2025

Related U.S. Application Data
(60) Provisional application No. 63/751,825, filed on Jan. 30, 2025.

(51) Int. Cl. B42D 3/02; B42D 1/00

(52) U.S. Cl. CPC B42D 3/02; B42D 1/004; B42P 2241/18

(57) ABSTRACT

A device for removably attaching a notebook cover having a spiral binding that includes a plurality of spirals. The device has a pair of coupling hooks, each of which defines a recess that can receive and retain at least one of the spirals, a divider between the hooks to retain the spirals in the recesses, and a center having a first part of a separable two-part fastener attached to the center. A connection post retained in an attachment hole of the notebook cover has a second part of the separable two-part fastener. The second part of the separable two-part fastener can be separably fastened to the first part of the separable two-part fastener of the connection clip to removably fasten the connection post to the connection clip, which is engaged with the spiral binding, so that the notebook cover is removably attached to the notebook.

### CROSS REFERENCE TO RELATED APPLICATIONS

This application claims priority to US provisional patent application 63751825 filed January 30, 2025.

### FIELD OF THE INVENTION

This invention relates generally to a device that allows switching notebook covers and accessories. As used herein, “notebooks”’ are books having blank pages for taking notes (but can also encompass books with preprinted pages), where the pages are bound in the notebook by a spiral wire binding. The spiral binding can be along the side, such as in a conventional notebook (sometimes called a composition book), or along the top, such as in a stenographer’s pad.

### BACKGROUND ART

Currently, there are a number of solutions for attaching covers to notebooks that have a spiral wire binding. However, although these solutions attempt to portray an illusion of interchangeability, they are not usable for different sizes or types of notebooks, like wire bound composition books and stenographer’s pad notebooks. Some require you to permanently glue a metal sheet to a notebook’s already-bound conventional cardboard cover, so the cover cannot be switched to a new notebook once all the pages are exhausted.

US Patent 6672785 to O’Hara discloses an insert for a notebook comprising a piece of sheet-like material having a plurality of wings, each of which has a central step and a pair of tip portions located on opposed sides of the central stem. Each tip portion extends inwardly toward the inner edge to define a coil receiving portion located between the stem and the associated tip portion. Each coil receiving portion is shaped and located to receive a turn of the coil therein to couple the insert to the coil.

US Patent Publication 2022/0144007 A1 (now US Patent 11465435) to Junglas et al discloses a device for removably coupling one or more sheets of stationery to a notebook where a portion of the coupling device, such as one or more arms, may extend through one or more holes in the stationery to retain the stationery in the notebook.

US Patent Publication 2013/0285359 A1 to Yeoman discloses a notebook cover having an area of ferrous metal and a corresponding decorative cover with a magnetic backing configured to magnetically adhere to the ferrous metal.

US Patent Publication 2017/0021661 A1 to Pelucchi discloses a fact sheet for insertion between the pages of a notebook, including a row of perforations into which the coils of the binding can be inserted to removably secure the sheet to the coils.

US Patent Publication 2017/0246902 A1 to Thurlow discloses a pen holder for engaging a spiral coil of a notebook having a series of slotted perforations configured to mesh with the spiral coil.

US Patent Publication 2008/0056852 A1 to Harris et al discloses a method for assembling a notebook having a spiral binding including the step of storing a plurality of covers having generally the same size and shape.

US Patent Publication 2012/0098246 A1 to He et al. discloses a repositionable notebook accessory comprising a panel and at least one hook feature configured and arranged to couple the panel to a spine of a notebook when the at least one gook is at least partially disposed within the spine.

US Patent Publication 2016/0236501 A1 to Koeppel discloses a notebook system with a plurality of disks having a generally planar central section and an enlarged peripheral rim, and sheets with an inner edge portion having a plurality of lots with an entryway channel.

US Patent Publication 2021/0237501 A1 to Fenney discloses a notebook with covers having retainer apertures along an edge, and pages with multiple perforations corresponding with those on the covers, and a helical binder which extends through the perforations, where the retaining apertures are different from the perforations, and the ends of the helical binder are shaped to fit through the perforations, but not the retaining apertures.

### SUMMARY OF THE INVENTION

The present invention comprises a device for removably attaching a notebook cover having a plurality of attachment holes to a notebook having a spiral binding that includes a plurality of spirals. A connection clip has a pair of coupling hooks, each of the hooks defining a recess that can receive and retain at least one of the spirals, a divider between the hooks to retain the at least one of the spirals in each of the two recesses, to engage the connection clip with the spiral binding, and a center having a first part of a separable two-part fastener attached to the center. A connection post is configured to be received and retained in attachment holes in the notebook cover, and has a second part of the separable two-part fastener. When the connection post is received and retained in one of the attachment holes, the second part of the separable two-part fastener can be separably fastened to the first part of the separable two-part fastener of the connection clip, so that the notebook cover is removably fastened to the connection clip, which is engaged with the spiral binding, so that the notebook cover is removably attached to the notebook.

Preferably, the two-part fastener is selected from the group consisting of two magnets, a magnet and a magnetic metal, a hook and loop fastener, and a snap fastener.

Preferably, the first part of the two-part fastener is a magnet and the second part of the two-part fastener is a magnetic metal or a magnet.

Preferably, at least one of the magnets is a neodymium magnet.

The present invention is a connection device, which couples to switchable front or back notebook covers of various sizes and types. The core components of the invention are a segment that attaches to the spiral binding of a spiral bound notebook, and a rigid segment that is attached to a front or back notebook cover. Generally speaking, the devices function as bridges between a spiral binding and a front or back notebook cover. The invention can be used to temporarily attach to the spine of a spiral bound notebook. The invention functions as a connection device for customized or personalized front or back notebook covers for users to retain and reuse their custom created notebook covers on new notebooks, after all notebook pages in an existing notebook have been used.

Notebook covers are essential elements of a notebook's structure, rather than just embellishments. For brevity, notebooks are hereinafter sometimes referred to as “books”. The cover’s major role is to safeguard the information within the book. Secondly, book covers are essential for creating a first impression; a well-crafted cover can accurately communicate the book's genre, tone, and narrative aspects, thereby appealing to the appropriate audience. The proliferation of laser technology and 3D printers, along with the accessibility of economical laser and 3D printing machines, has led to a growing availability to customize or personalize notebook covers. It would be desirable to have switchable front and/or back notebook covers that can be placed on a new spiral notebook, without the need to recreate the covers from an existing notebook. The disclosed device advantageously fills this need and addresses the aforementioned deficiencies by providing a non-permanent connection device so that users can keep their personalized notebook covers from an existing notebook after all the pages have been used, by providing a connecting mechanism for interchangeable front and/or back notebook covers. This also provides the user the ability and flexibility to modify their current notebook with different customized or personalized notebook covers at any time, making it possible to retain and reuse their custom created notebook covers once all pages are exhausted.

Preferably, the device comprises a connection clip and a post. The post is attached to the notebook cover, while the connection clip is removably fastened to the post, and also engaged with the spiral binding of a spiral-bound notebook. These components are coupled as follows: the cover clip connection device is one piece and the connection post device is one piece. On one end of the connection clip device is a component that engages with the binding of a spiral-bound notebook, and the opposite end is a component that removably attaches to the notebook cover post. Each post is preferably retained in the notebook cover by a suitably sized and configured hole.

The device may also include one or more of the following to removably attach the clip and the post together: magnets, hook and loop fasteners, or snap fasteners, such as metal disks and springs.

The disclosed device is unique when compared with other known devices and solutions because it provides: (1) the ability to attach to different types of spiral-bound notebook or stenographer’s pad notebooks (where the spiral binding is on the side or on the top, respectively); (2) the ability to attach and detach customized notebook covers to a spiral bound notebook at any point along the spiral wire, regardless of whether the spiral wire is located on the top, bottom, left or right of a notebook; and (3) the ability to transfer the same notebook cover to a new notebook, regardless of whether the location of the spiral wire is the same on the new notebook.

The disclosed device is unique in that it is structurally different from other known devices or solutions. More specifically, the device is unique due to the ability to independently attach and detach each clip and post from the spiral wire or the notebook cover.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. This connection device that will allow you to switch customizable notebook covers and accessories may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

FIG. 1 is a plan view from below of the connection clip.

FIG. 2 is a perspective view from the back of the connection clip.

FIG. 3 is a perspective view from the front of the connection clip.

FIG. 4 is a perspective view from the right of the connection clip, a view from perspective view from the left being a mirror image thereof.

FIG. 5 is a plan view from above of the connection clip.

FIG. 6 is a plan view from above of a connection post.

FIG. 7 is a perspective view from above of the connection post being inserted into a hole in a notebook cover.

FIG. 8 is a perspective view below of the connection post being inserted into a hole in a notebook cover.

FIG. 9 is an elevational view from the right of the connection post, the elevational view from the left being a mirror image thereof.

FIG. 10 is a plan view from the top of the connection clip and a spiral binding.

FIG. 11 is an elevational view from the right of the connection clip, connection post and spiral binding.

FIG. 12 is a perspective view from above of the connection clip, connection post and spiral binding.

FIG. 13 is a perspective view from below of the connection clip, connection post, notebook and spiral binding.

FIG. 14 is a plan view from above of a notebook cover, connection clip and connection post with accessories, with the spiral binding on the side.

FIG. 15 is an overhead view of a stenographer’s pad cover, connection clip and connection post with accessories, with the spiral binding on the top.

FIG. 16 is a perspective view from above of a notebook cover, connection clip, connection post, and spiral binding with accessories, with the spiral binding on the side.

FIG. 17 is a perspective view from above of a stenographer’s pad cover, connection clip, connection post, and spiral binding with accessories, with the spiral binding on the top.

FIG. 18 is a plan cutaway view from the inside of the notebook cover, connection clip, connection post, and pocket with accessories, with the spiral binding on the side.

FIG. 19 is a plan cutaway view from the inside of a stenographer’s pad cover, connection clip, connection post, and pocket with accessories, with the spiral binding on the top.

### DETAILED DESCRIPTION OF THE PRESENTLY PREFERRED EMBODIMENT

The presently preferred embodiment of the present invention is a clip and post that will allow you to switch customizable notebook covers and accessories. In its most complete version, the device is made up of the following components; a part that connects to a spiral wire and a part that connects to a post attachable to the notebook cover. These components are connected as follows: The connection clip is a singular unit approximately 1/2 inch by 1/2 inch. One end of the connection clip features a component that joins to a spiral-bound notebook, while the opposite end of the connection clip includes a component that secures to a post in the notebook covers. The connection post is a singular unit approximately 1/2 inch by 1/2 inch. One end of the connection post preferably is embedded in and protrudes through the notebook cover and secures to the connection clip. It should further be noted that the connection devices can be formed from many different materials including, but not limited to metals, plastics or polymers.

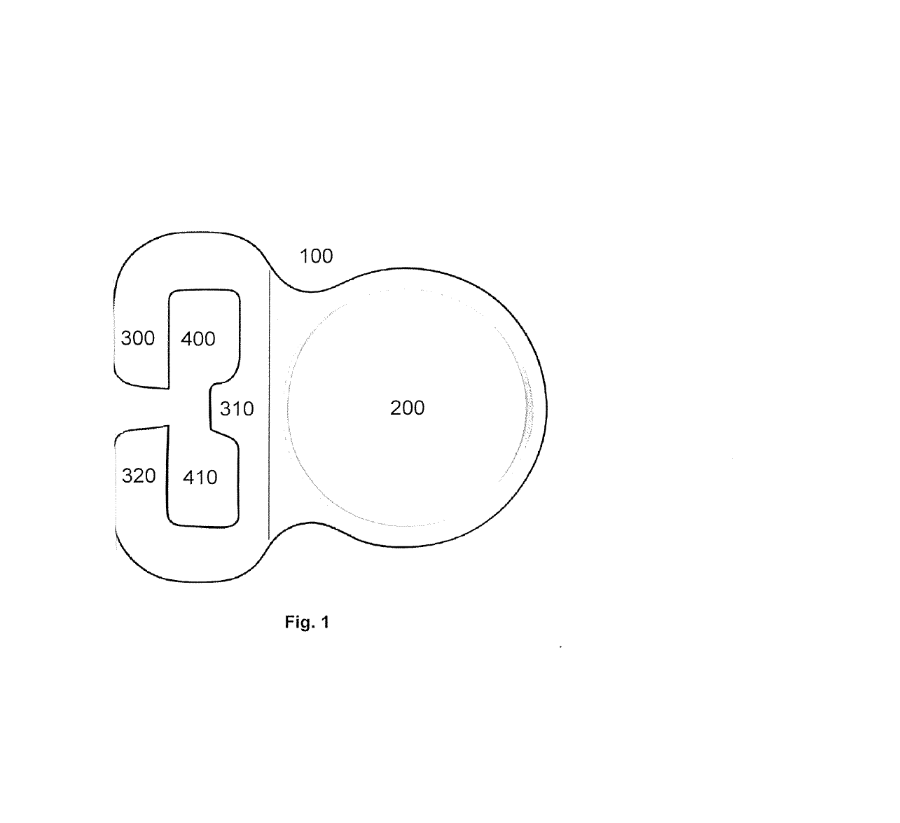

FIG. 1 shows a plan view from the bottom of the connection clip 100. In this particular embodiment, the connection clip 100 is shown with a pair of coupling hooks 300 and 320. The hooks 300 and 320 engage with the spirals or coils of a spiral wire notebook that can have varying degrees of thickness, diameter and turn spacing. The spirals or coils pass through recesses 400 and 410, and each of the two hooks 300 and 320 retains at least one of the spirals in order to engage the connection clip 100 with the spiral binding. Thus, the connection clip 100 can be used with notebooks having spiral bindings with spirals or coils that are spaced apart differently from the spacing between the recesses 400 and 410. A divider 310 between the two hooks helps keep the retained spirals or coils of the binding in the two recesses 400 and 410. A piece of magnetic metal or a magnet (that couples to a complementary magnetic metal post or magnetic post that is on the notebook cover) is preferably attached to, or embedded, in the center 200. Preferably, the magnet is a neodymium or other sufficiently strong magnet. Instead of a magnet, a metal or plastic snap fastener or hook and loop (not shown) can be embedded or attached in the center 200. The connection clip 100 may comprise a magnetic metal, a plastic, a polymer, or some other suitable material.

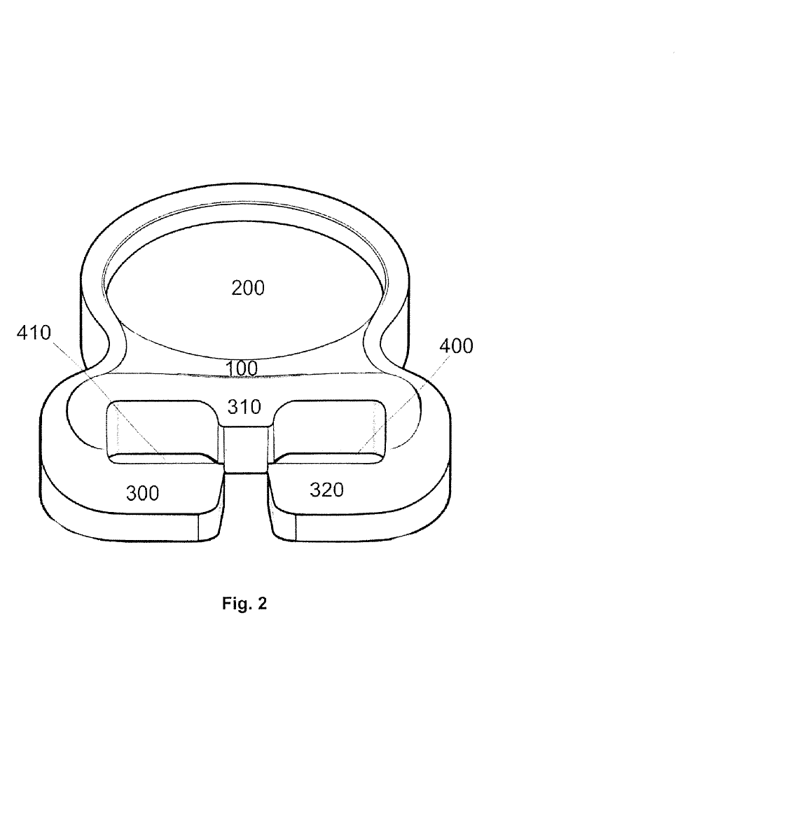

FIG. 2 shows a perspective view from the back of the connection clip 100. In this particular embodiment, the connection clip 100 is shown with a pair of coupling hooks 300 and 320 each of which engages with the coils or spirals of a spiral wire notebook that can have varying degrees of thickness, diameter and turn spacing. The spirals or coils of the spiral binding pass through recesses 400 and 410 and two or more are retained by the two hooks 300 and 320 to engage the connection clip 100 with the spiral binding. The divider 310 helps keep the spirals or coils of the spiral binding in the two recesses 400 and 410. A metal piece or magnet that couples to a metal piece or magnet post on the notebook cover is preferably embedded in, or attached to, the center 200. Preferably, the magnet is a neodymium or other sufficiently strong magnet. Instead of a magnet, a metal or plastic snap fastener or hook and loop (not shown) can be embedded or attached in the center 200. The connection clip 100 may comprise a magnetic metal, a plastic, a polymer, or some other suitable material.

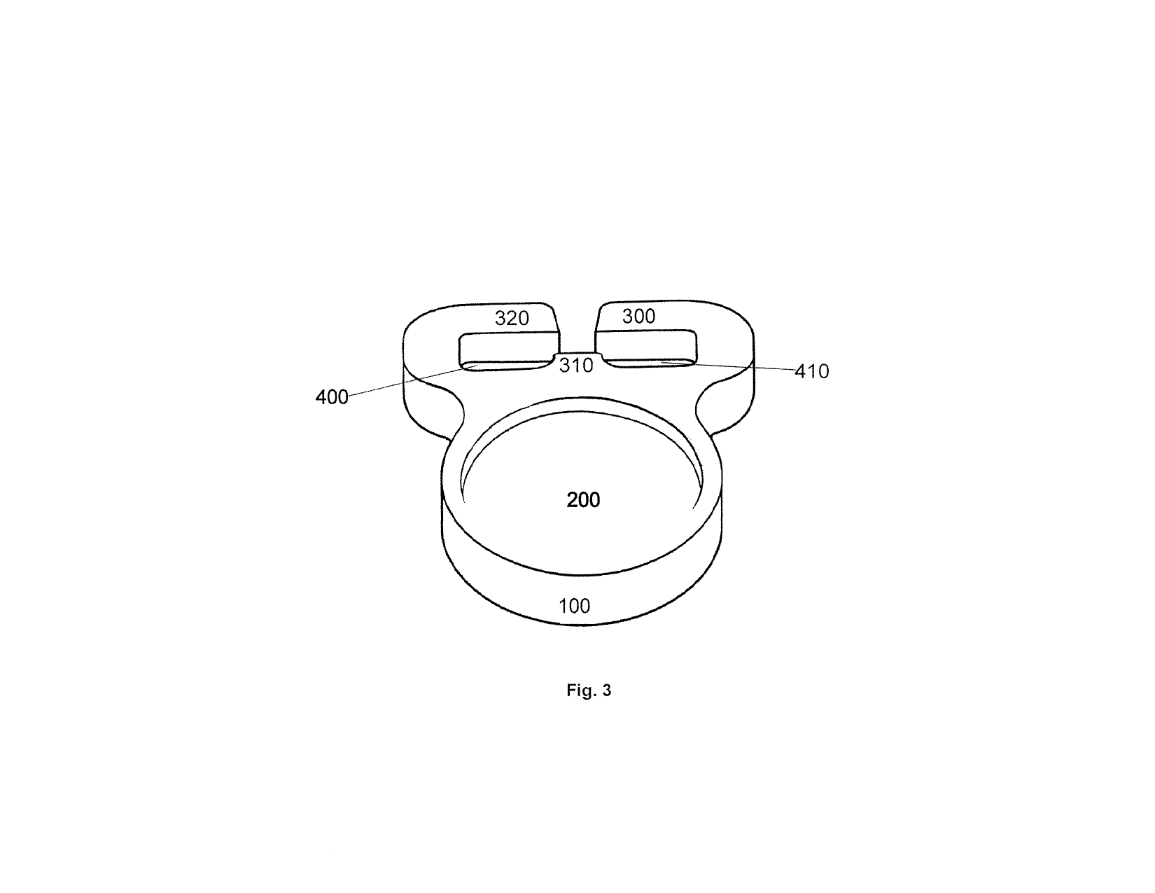

FIG. 3 shows a perspective view from the front of the connection clip 100. In this particular embodiment, the connection clip 100 is shown with a pair of coupling 300 and hooks 320 that attaches to the spirals or coils of a spiral wire notebook having varying degrees of thickness, diameter and turn spacing. The spirals or coils of the spiral binding pass through the openings 400 and 410 and two or more are retained by the two hooks 300 and 320 to engage the connection clip 100 with the spiral binding. The divider 310 helps keep the spiral binding in the two recesses 400 and 410. The center 200 preferably will have an embedded metal piece or magnet that couples to a metal piece or magnet post on the notebook cover. Instead of a magnet you may also have a metal or plastic snap fastener or hook and loop (not shown). The connection clip 100 may comprise of metals or polymers.

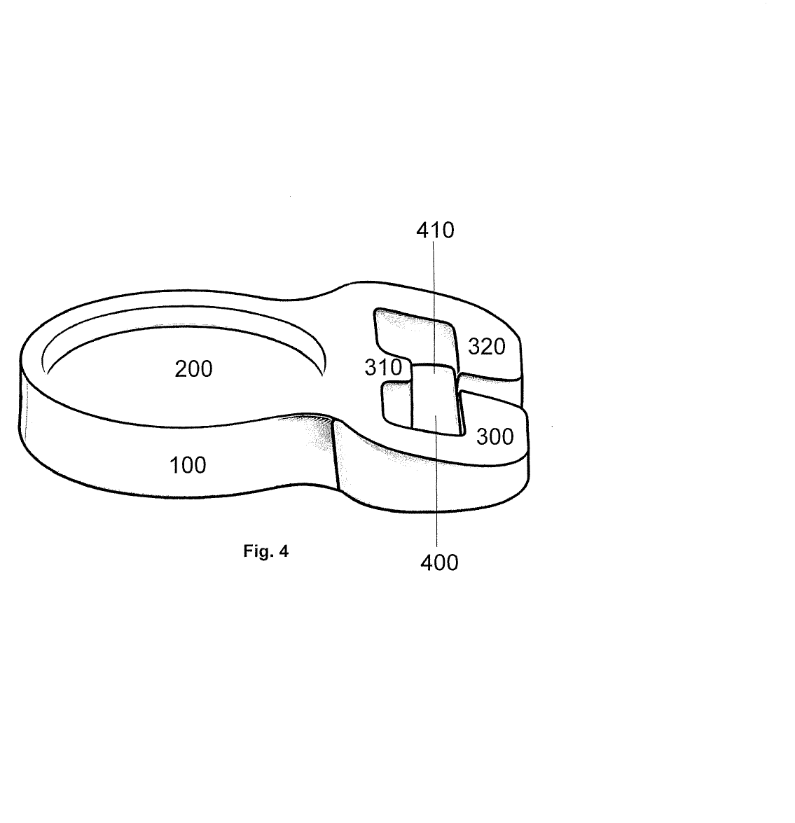

FIG. 4 shows a perspective view from the right of the connection clip 100, and the perspective view from the left being a mirror image thereof. In this particular embodiment, the connection clip 100 is shown with a pair of coupling hooks 300 and 320 that attach to the spirals or coils of a spiral wire notebook having varying degrees of thickness, diameter and turn spacing. The spirals or coils of the spiral binding pass through the openings 400 and 410 and are captured by the two hooks 300 and 320 to engage the connection clip 100 with the spiral binding. The divider 310 helps keep the spirals of the spiral binding in the two recesses 400 and 410. In the center 200 you will have an embedded metal piece or magnet that couples to a metal piece or magnet post on the notebook cover. Instead of a magnet you may also have a metal or plastic snap fastener or hook and loop (not shown). The connection clip 100 may comprise of metals or polymers.

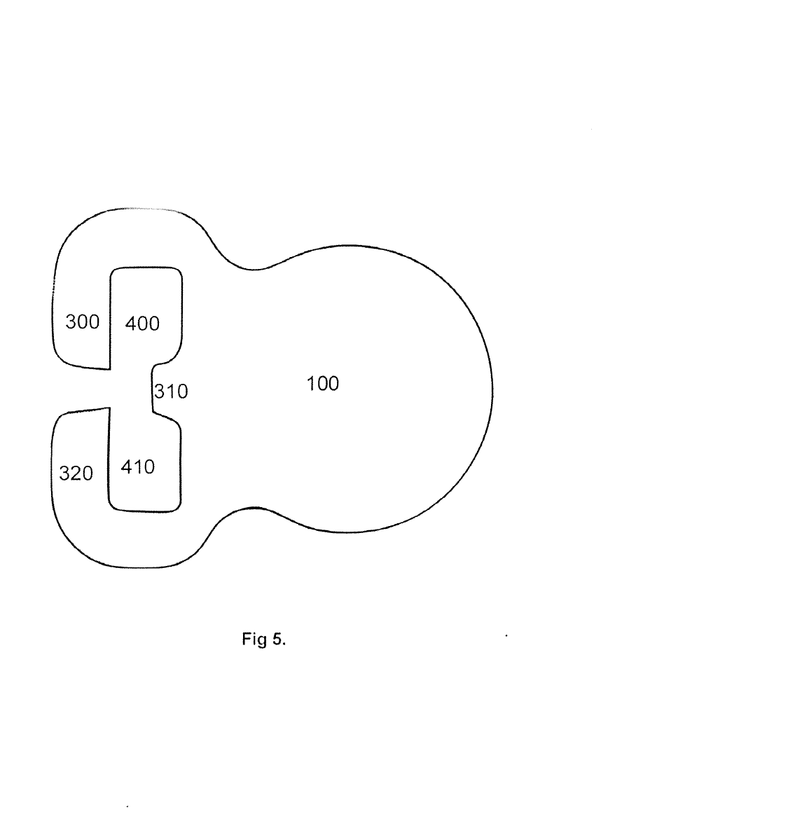

FIG. 5 shows a plan view from above of the connection clip 100. In this particular embodiment, the connection clip 100 is shown with a pair of coupling hooks 300 and 320 that attach to a spiral wire notebook of varying degrees of thickness, diameter and turn spacing. The spirals of the spiral binding pass through the openings 400 and 410 and are captured by the two hooks 300 and 320. The divider 310 helps keep the spiral binding in the two recesses 400 and 410. The connection clip 100 may comprise of metals or polymers.

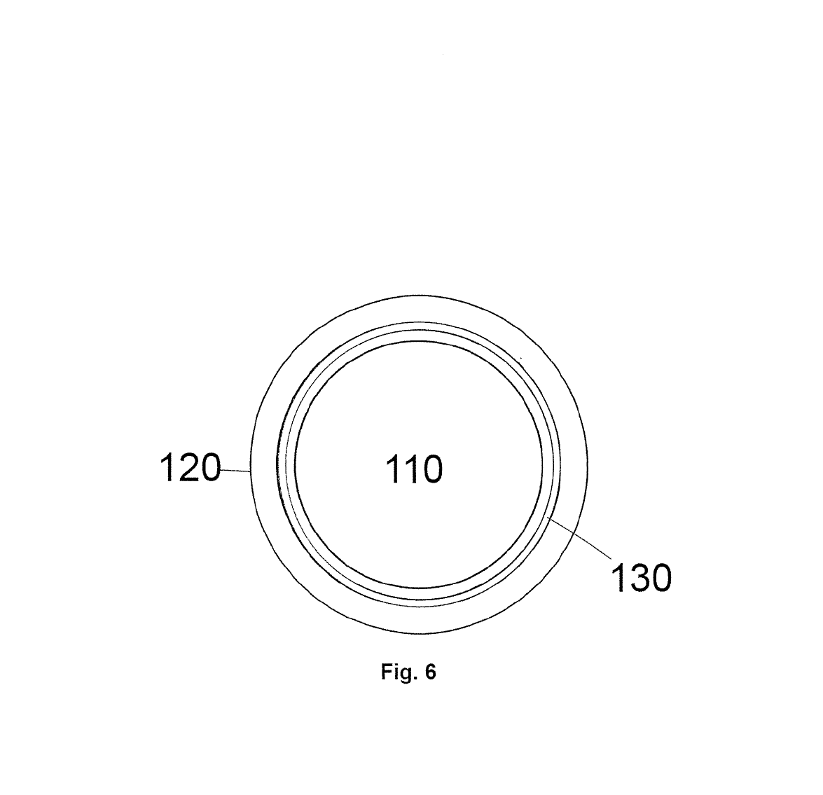

FIG. 6 shows a plan view from above of a presently preferred embodiment of the connection post 110. In this particular illustrated embodiment, the connection post 110 is shown with a cylinder shape, with a larger diameter base 120 that functions as a stop. Mid way on the post 110 is a beveled ring 130 that prevents the post from backing out of an approximately 1/2-inch diameter hole once inserted into the notebook cover. The space between the base 120 and the beveled ring 130 is approximately 1/16 inches to accommodate a 1/16-inch-thick notebook cover. Imbedded in, or attached to, the post 110 are a magnetic metal piece or sufficiently strong magnet that attach to a complementary magnetic metal piece or sufficiently strong magnet in the connection clip. Preferably, the magnet is neodymium. Instead of a magnet, a metal or plastic snap fastener or hook and loop (not shown) or other type of fastener complementary to a fastener in the connection clip can be used. The connection post 110 may comprise of metals, plastics, polymers, or other suitable materials.

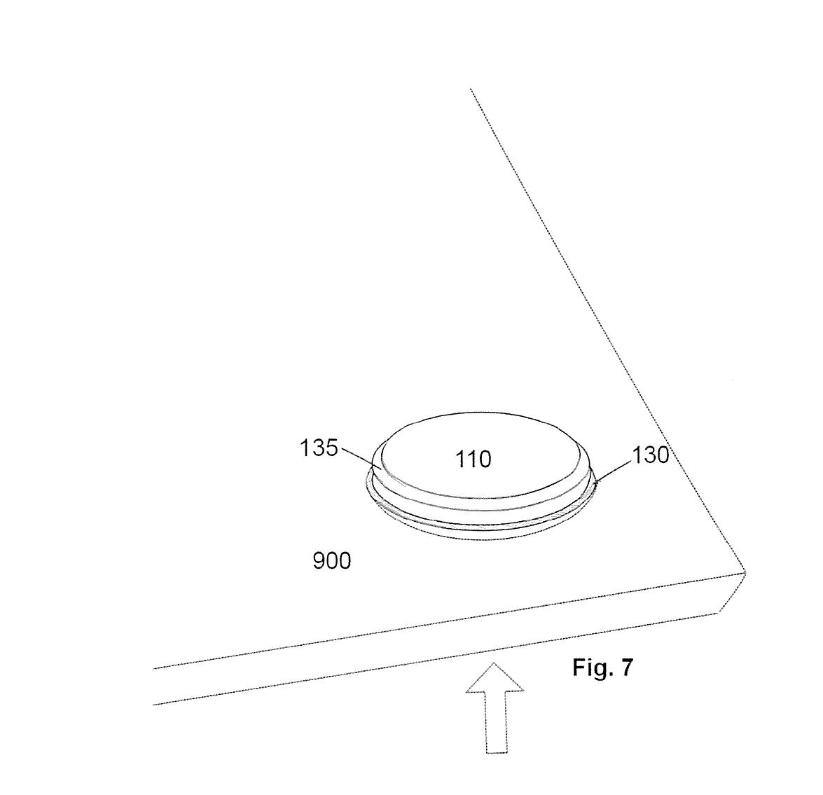

FIG. 7 shows a perspective view from above of the connection post 110 being inserted into a hole in a notebook cover. In this particular embodiment, the connection post 110 is shown with a cylinder shape, with a beveled ring 130 that prevents the post from backing out of an approximately 1/2 inch diameter hole in the notebook cover 900, once inserted into the notebook cover 900. Preferably, a connection clip portion 135 of the cylinder post extends approximately 1/16 inch past the beveled ring 130 and connects to the connection clip. The space between the base 120 and the beveled ring 130 is approximately 1/16 inches to accommodate a 1/16-inch-thick notebook cover 900. Imbedded in the post 110 you will have a metal piece or magnet cylinder that couples to a metal piece or magnet cylinder in the connection clip. Instead of a magnet you may also have a metal or plastic snap fastener or hook and loop (not shown). The connection post 110 may comprise of metals or polymers.

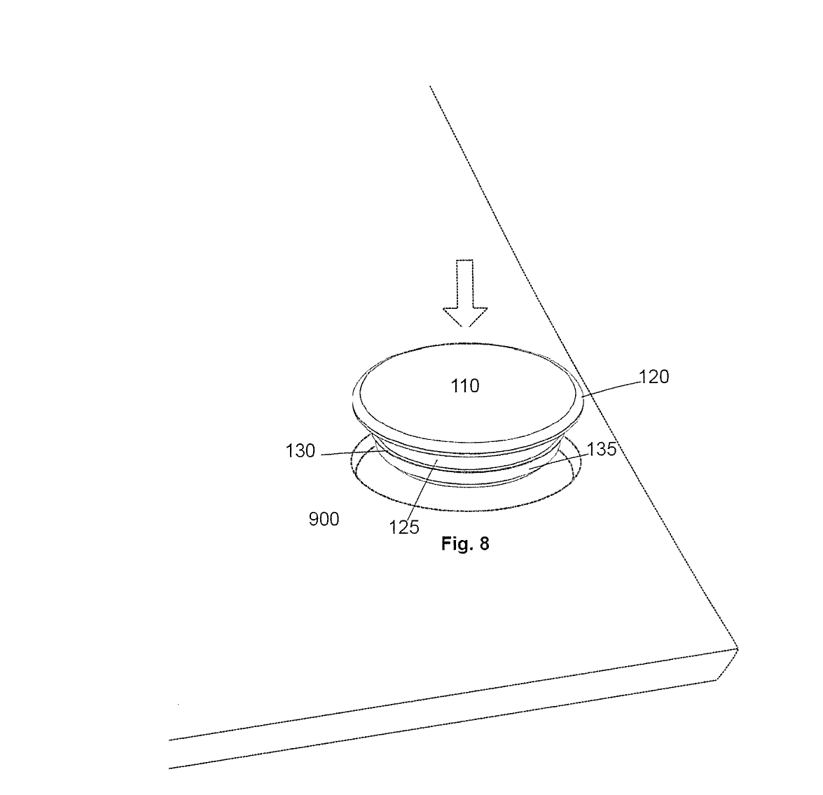

FIG. 8 shows a perspective angle view from the bottom of the connection post 110 being inserted into a hole in a notebook cover. In this particular embodiment, the connection post 110 is shown with a cylinder shape, a larger diameter base 120 that functions as a stop, with a beveled ring 130 that prevents the post from backing out of an approximately 1/2-inch diameter hole in the notebook cover 900, once inserted into the notebook cover 900. Preferably, a connection clip portion 135 of the cylinder post extends approximately 1/16 inch past the beveled ring 130 and connects to the connection clip. The space 125 between the base and the beveled ring 130 is approximately 1/16 inches to accommodate a 1/16-inch-thick notebook cover 900. Imbedded in the post 110 you will have a metal piece or magnet cylinder that couples to a metal piece or magnet cylinder in the connection clip. Instead of a magnet you may also have a metal or plastic snap fastener or hook and loop (not shown). The connection post 110 may comprise of metals or polymers.

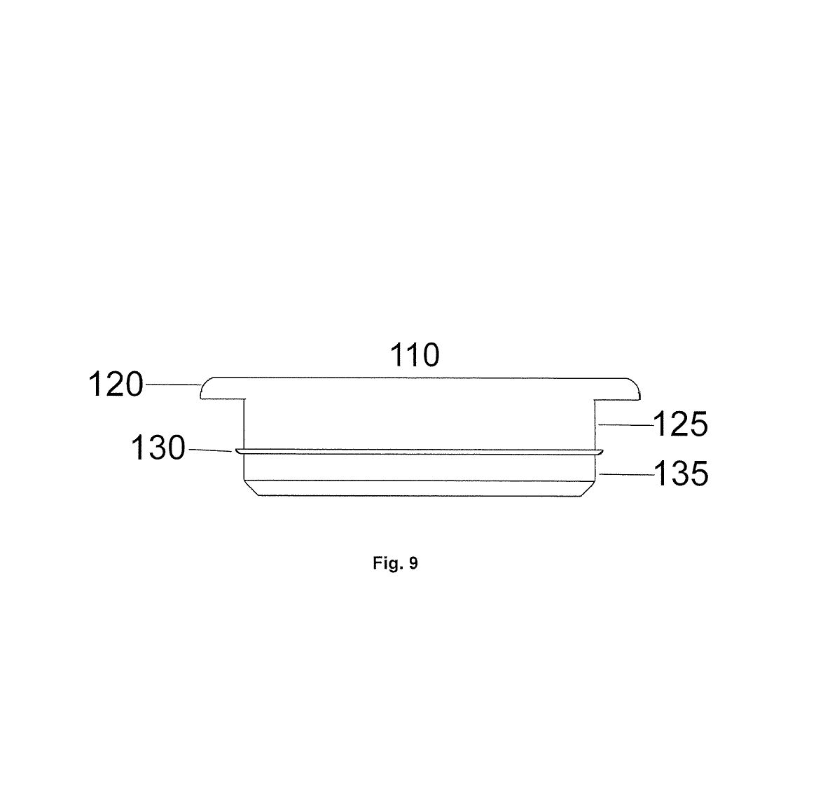

FIG. 9 shows an elevational view from the right of the connection post 110, the view from the left being a mirror image thereof. In this particular embodiment, the connection post 110 is shown with a cylinder shape, a larger diameter base 120 that functions as a stop and a beveled ring 130. Preferably, a connection clip portion 135 of the cylinder post extends approximately 1/16 inch past the beveled ring 130 and connects to the connection clip. The space 125 between the base and the beveled ring 130 is approximately 1/16 inches to accommodate a 1/16-inch-thick notebook cover. Embedded in the post 110 you will have a metal piece or magnet cylinder that couples to a metal piece or magnet cylinder in the connection clip. Instead of a magnet you may also have a metal or plastic snap fastener or hook and loop (not shown). The connection post 110 may comprise of metals or polymers.

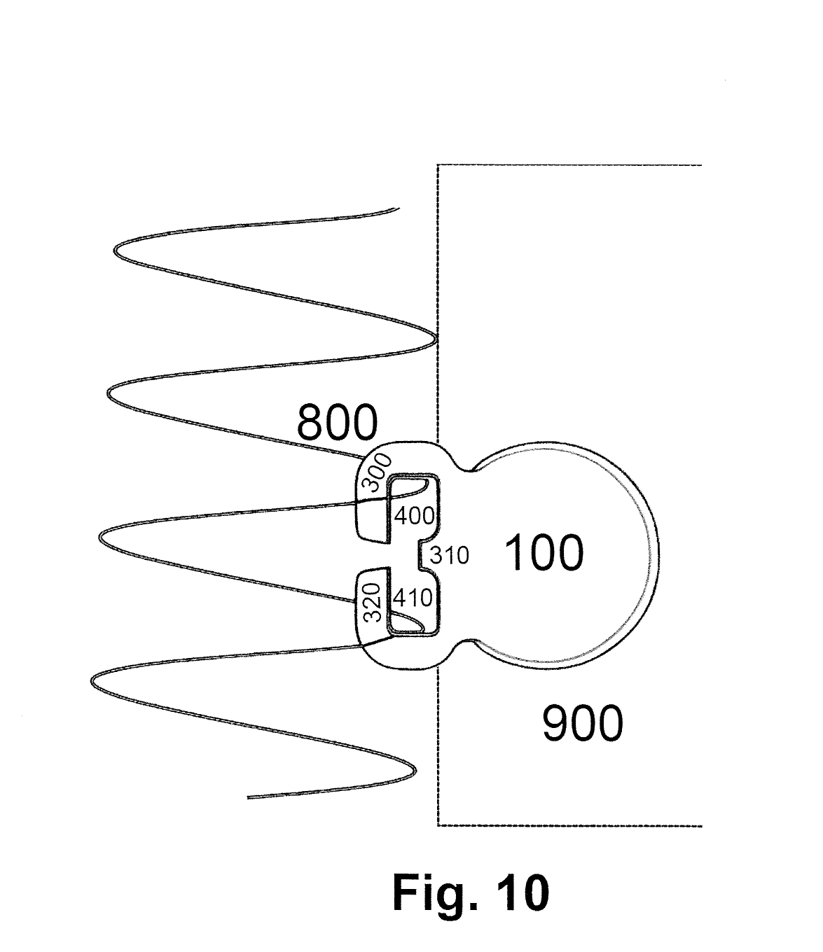

FIG. 10 shows a perspective view from the top of the connection clip 100 engaged with a spiral wire 800 of the spiral binding of a notebook, and connecting to the post 110 (not shown). The spiral wire 800 passes through the openings 400 and 410 and is captured by the two hooks 300 and 320. The recess 310 divider helps keep the spiral binding 800 in the two recesses 400 and 410.

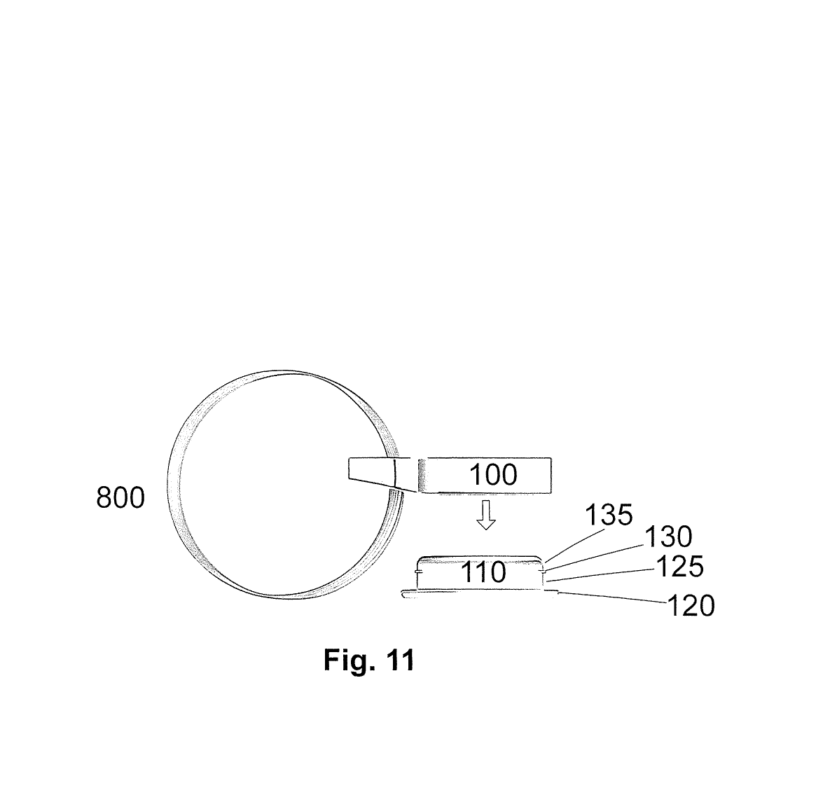

FIG. 11 shows a perspective view from the right side of the connection clip 100, connection post 110 and spiral binding 800 and the view from the left being a mirror image thereof. The spiral wire of the spiral binding 800 passes through the openings 400 and 410 and is captured by the two hooks 300 and 320. The connection post 110 is shown with a cylinder shape, with a beveled ring 130. The connection clip portion 135 extends the connection post 110 approximately 1/16 inch past the beveled ring 130. The space 125 between the base and the beveled ring 130 is approximately 1/16 inches to accommodate a 1/16-inch-thick notebook cover.

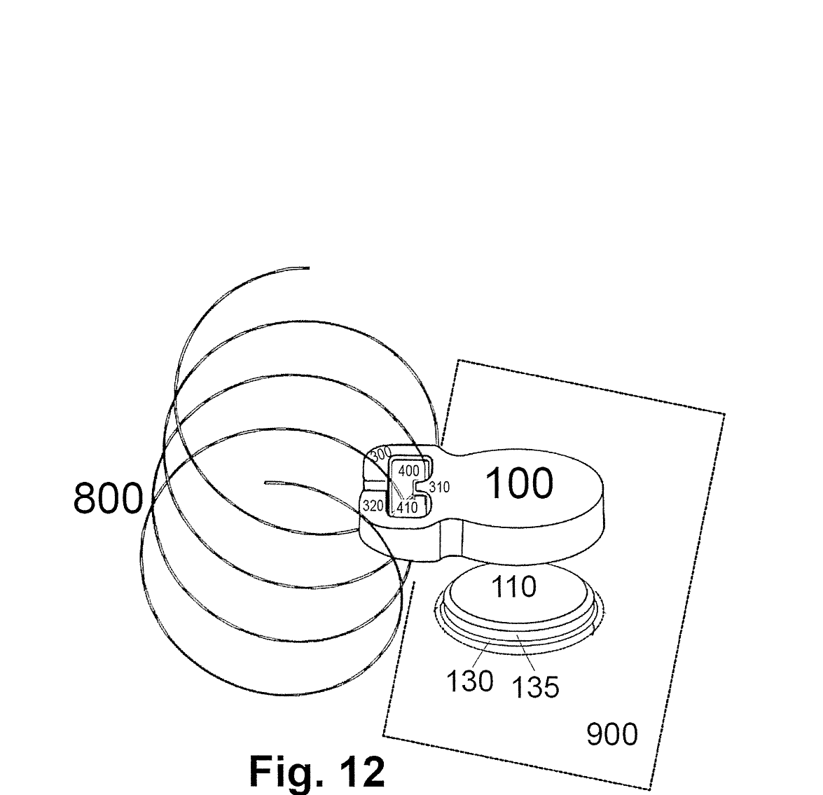

FIG. 12 shows a perspective view from above of the connection clip 100, connection post 110 and spiral binding 800. The spiral wire of the spiral binding 800 passes through the openings 400 and 410 and is captured by the two hooks 300 and 320. The connection post 110 is shown with a cylinder shape, with a beveled ring 130. The cylinder post will extend 135 approximately 1/16 inch pass the beveled ring 130 and connect to the connection clip 100.

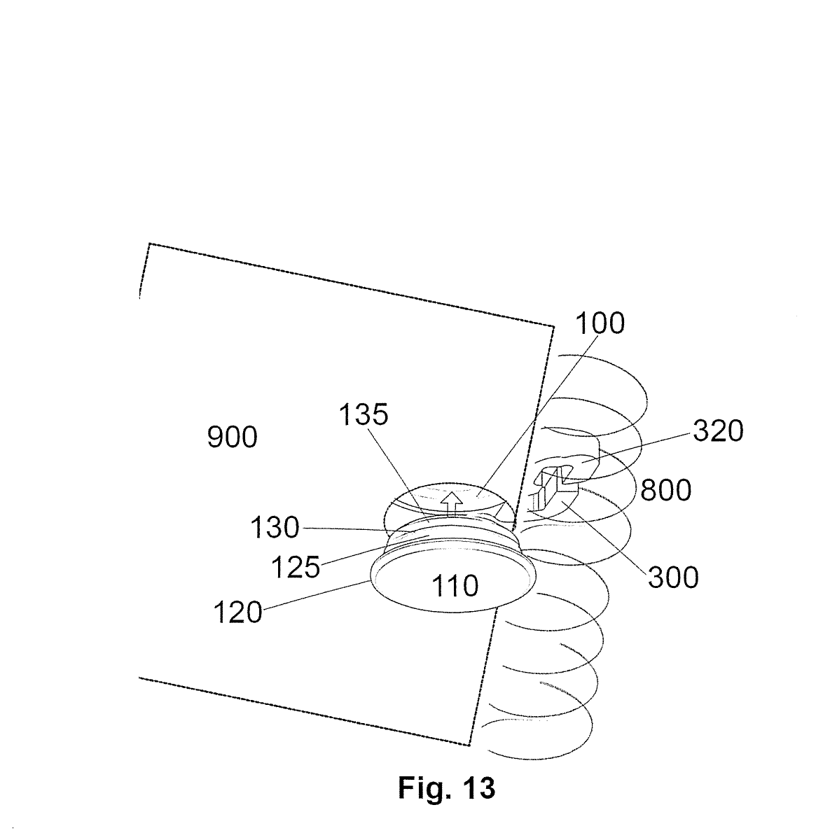

FIG. 13 shows a perspective angle view from the bottom of the connection clip 100, connection post 110, notebook cover 900 and spiral binding 800. The spiral wire 800 passes through the opening and is captured by the two hooks 300 and 320. The connection post 110 is shown with a cylinder shape, with a beveled ring 130. The connection clip portion 135 extends the cylinder post approximately 1/16 inch past the beveled ring 130 and allows connection to the connection clip. The space 125 between the base and the beveled ring 130 is approximately 1/16 inches to accommodate a 1/16-inch-thick notebook cover 900.

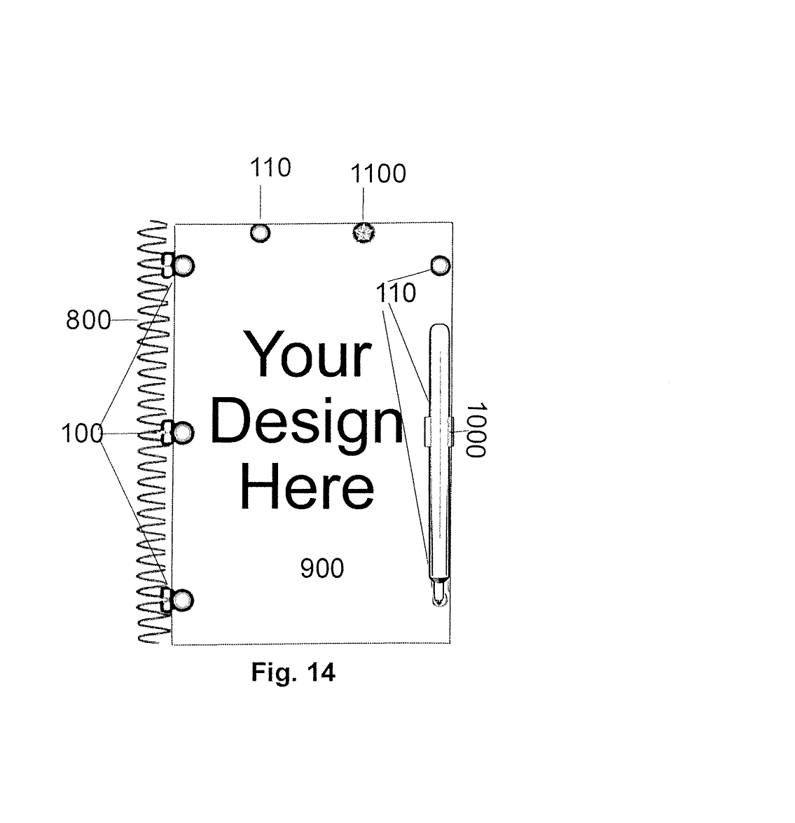

FIG. 14 shows a plan view from above of a notebook cover 900, with connection clips 100 and connection posts 110. In this particular illustrated embodiment, the connection clips 100 are coupled to certain connection posts 110 (not visible) embedded in the notebook cover 900 and the connection clips 100 are engaged with a spiral wire binding 800 at different locations corresponding closely enough to the locations of connection posts 110 (not visible) embedded in the notebook cover 900, that the connection clips 100 can each engage with the wire binding 800. The notebook cover 900 can have one or more additional connection posts 110 embedded around the notebook cover 900 to allow additional points of attachment. The additional connection posts 110 will allow for attaching to a wire binding in a different location on a new notebook, and will also allow for various accessories, such as a pen clip 1000, or magnetic charms 1100. The notebook covers 900 can be comprised of wood, leather, metal or plastic.

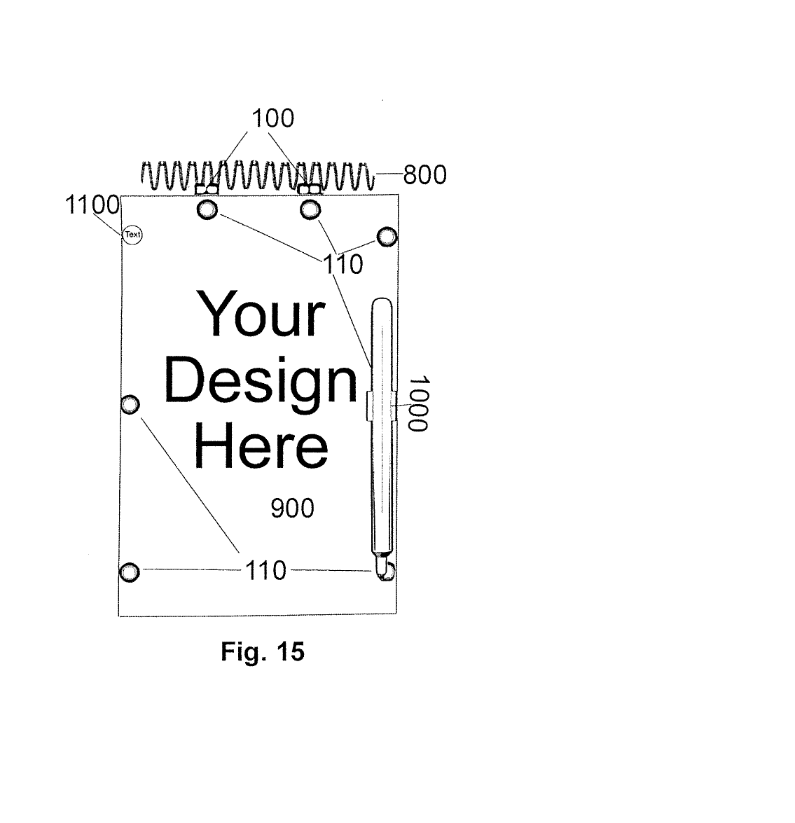

FIG. 15 shows a perspective view of a stenographer’s pad cover 900, with connection clips 100 and connection posts 110. In this particular illustrated embodiment, connection clips 100 are coupled to certain connection posts 110 (not visible) embedded in the notebook cover 900 and the connection clips 100 are engaged with a spiral wire binding 800 at different locations corresponding closely enough to the locations of connection posts 110 (not visible) embedded in the notebook cover 900, that the connection clips 100 can each engage with the wire binding 800. The notebook cover 900 can have one or more additional connection posts 110 embedded around the notebook cover 900 to allow additional points of attachment. The additional connection posts 110 will allow for attaching to a wire binding in a different location on a new notebook, and will also allow for various accessories, such as a pen clip 1000, or magnetic charms 1100. The notebook covers 900 can be comprised of wood, leather, metal or plastic.

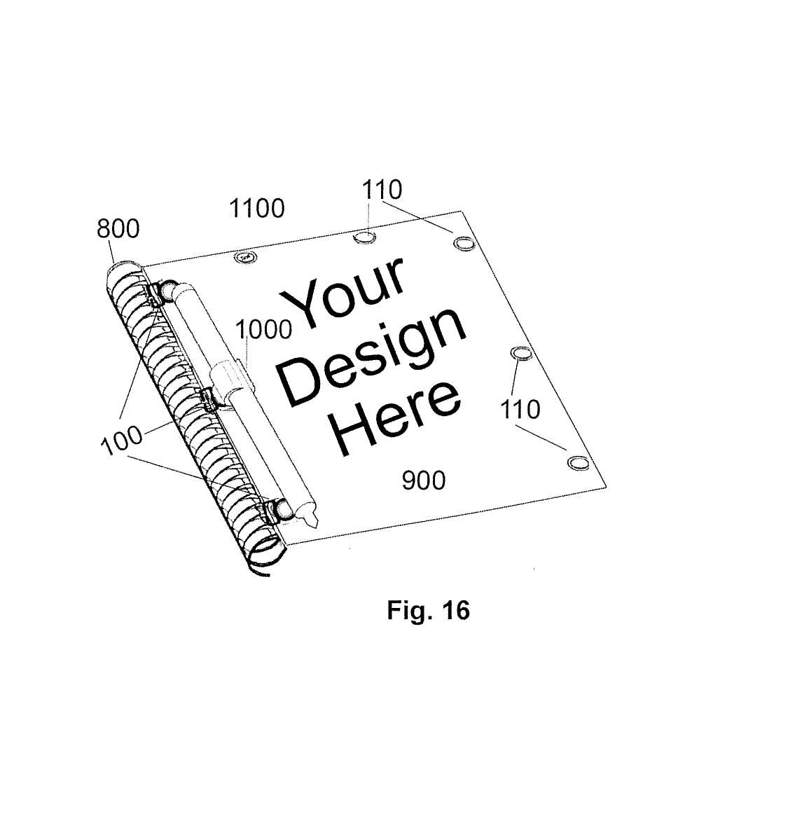

FIG. 16 shows a perspective view of a notebook cover 900, with connection clips 100 and connection posts 110. In this particular illustrated embodiment, the connection clips 100 are coupled to certain connection posts 110 (not visible) embedded in the notebook cover 900 and the connection clips 100 are engaged with a spiral wire 800 at different locations corresponding closely enough to the locations of connection posts 110 (not visible) embedded in the notebook cover 900, that the connection clips 100 can each engage with the wire binding 800. The notebook cover 900 can have one or more additional connection posts 110 embedded around the notebook cover 900 to allow additional points of attachment. The additional connection posts 110 will allow for attaching to a wire binding in a different location on a new notebook, and will allow for various accessories, such as a pen clip 1000, or magnetic charms 1100. The notebook covers 900 can be comprised of wood, leather, metal or plastic.

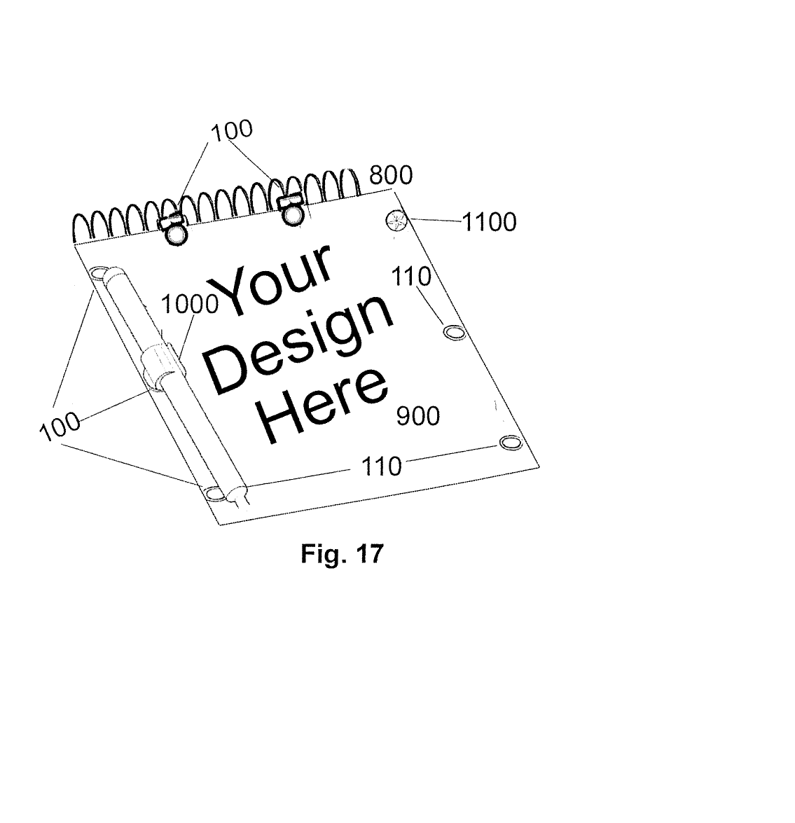

FIG. 17 shows a perspective view of a stenographer’s pad cover 900, with connection clips 100 and connection posts 110. In this particular illustrated embodiment, the connection clips 100 are coupled to certain connection posts 110 (not visible) embedded in the notebook cover 900, and the connection clips 100 are engaged with a spiral wire binding 800 at different locations corresponding closely enough to the locations of connection posts 110 (not visible) embedded in the notebook cover 900, that the connection clips 100 can each engage with the wire binding 800. The notebook cover 900 can have one or more additional connection posts 110 embedded around the notebook cover 900 to allow additional points of attachment. The additional connection posts 110 will allow for attaching to a wire binding in a different location on a new notebook, and will allow for various accessories, such as a pen clip 1000, or magnetic charms 1100. The notebook covers 900 can be comprised of wood, leather, metal or plastic.

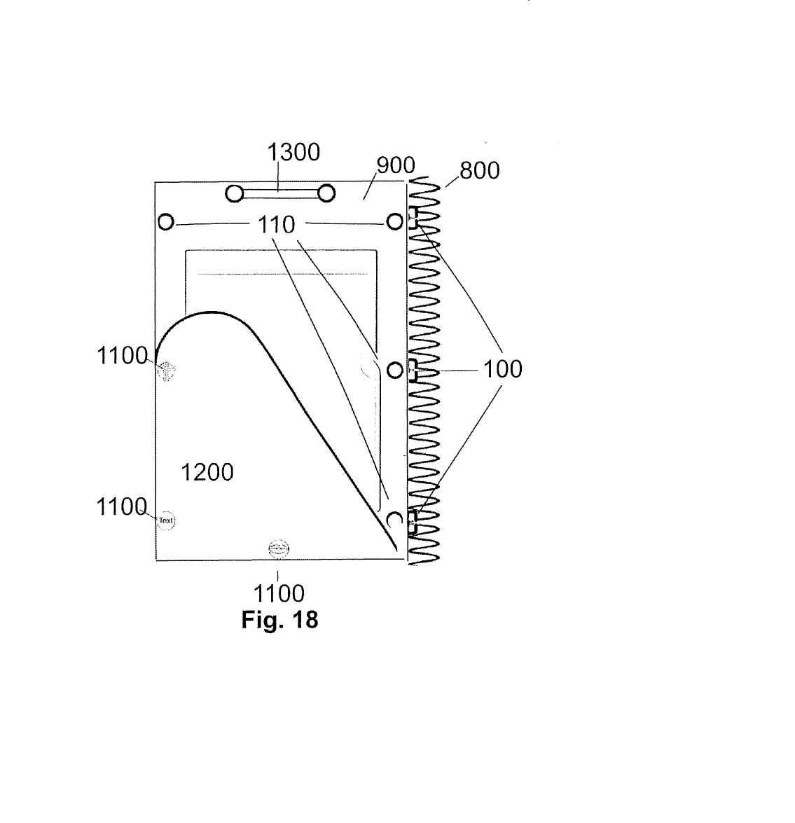

FIG. 18 shows a notebook cover 900 from the inside, and connection posts 110. In this particular illustrated embodiment, certain connection clips 100 (not visible) are coupled to certain connection posts 110 that are close enough to the wire binding 800 that the connection clips 100 can engage with the wire binding 800, thereby connecting the notebook cover 900 to the spiral binding 800. The notebook cover 900 can have one or more additional connection posts 110 embedded around the notebook cover 900 to allow additional points of attachment. The additional points of attachment will allow for attaching to a wire binding in a different location on a new notebook, and will allow for attachment of various accessories, such as magnetic charms 1100, notebook pocket 1200, and a magnetic clip bar 1300. The notebook covers 900 can be comprised of wood, leather, metal or plastic.

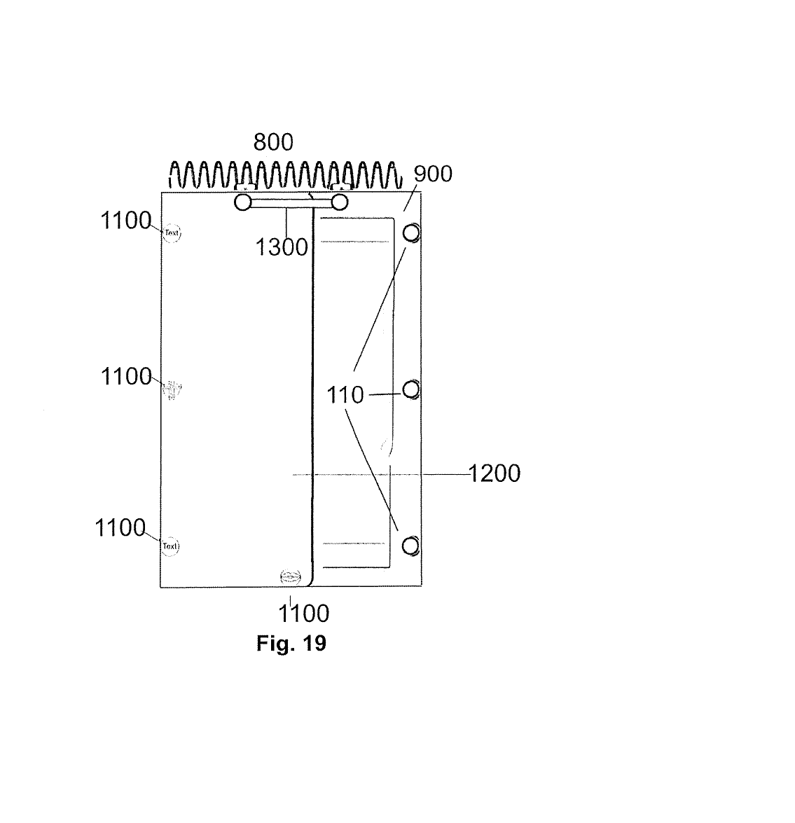

FIG. 19 shows a stenographer’s pad cover 900 from the inside, and connection posts 110. In this particular illustrated embodiment, certain connection clips 100 (not visible) are coupled to certain connection posts 110 that are close enough to the wire binding 800 that the connection clips 100 can engage with the wire binding 800, thereby connecting the notebook cover 900 to the spiral binding 800. The notebook cover 900 can have additional connection posts 110 embedded around the notebook cover 900 to allow multiple points of attachment. The multiple points of attachments will allow for attaching to a wire binding in a different location on a new notebook, and will allow for attachment of various accessories, such as magnetic charms 1100, notebook pocket 1200, and a magnetic clip bar 1300. The notebook covers 900 can be comprised of wood, leather, metal or plastic.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

### INDUSTRIAL APPLICABILITY

This invention is applicable whenever it is desired to provide interchangeable notebook covers to a notebook having a spiral binding.

What is claimed is:

1. A device for removably attaching a notebook cover having a plurality of attachment holes to a notebook having a spiral binding that includes a plurality of spirals, comprising:
a connection clip having a pair of coupling hooks, each of said hooks defining a recess that can receive and retain at least one of said spirals, a divider between said hooks to retain said at least one of said spirals in each of said two recesses, to engage said connection clip with said spiral binding, and a center having a first part of a separable two-part fastener attached to said center; and
a connection post configured to be received and retained in said attachment holes in said notebook cover, having a second part of said separable two-part fastener;
whereby, when said connection post is received and retained in one of said attachment holes, said second part of said separable two-part fastener can be separably fastened to said first part of said separable two-part fastener of a connection clip;
whereby said notebook cover is removably fastened to said connection clip, and said connection clip is engaged with said spiral binding;
whereby said notebook cover is removably attached to said notebook.

2. A device according to claim 1, wherein said two-part fastener is selected from the group consisting of two magnets, a magnet and a magnetic metal, a hook and loop fastener, and a snap fastener.

3. A device according to claim 1, wherein said first part of said two-part fastener is a magnet and said second part of said two-part fastener is selected from the group consisting of a magnetic metal and a magnet.

4. A device according to claim 3, wherein at least one of said magnets is a neodymium magnet.
